(19) United States
(12) Patent Application Publication
(10) Pub. No.: US 2016/0177816 A1
(43) Pub. Date: Jun. 23, 2016

(54) TWO-STROKE ENGINE

(71) Applicants: Manousos Pattakos, Nikea Piraeus (GR); John Pattakos, Nikea Piraeus (GR); Efthimios Pattakos, Nikea Piraeus (GR); Emmanouel Pattakos, Nikea Piraeus (GR)

(72) Inventors: Manousos Pattakos, Nikea Piraeus (GR); John Pattakos, Nikea Piraeus (GR); Efthimios Pattakos, Nikea Piraeus (GR); Emmanouel Pattakos, Nikea Piraeus (GR)

(21) Appl. No.: 14/948,405

(22) Filed: Nov. 23, 2015

(30) Foreign Application Priority Data
Dec. 23, 2014 (GB) 1423117.9

(51) Int. Cl. F02B 75/04; F02B 75/00; F02F 3/24; F02B 75/02

(52) U.S. Cl. CPC F02B 75/044; F02B 75/02; F02B 75/002; F02F 3/24; F02B 2075/025

(57) ABSTRACT

A two-stroke engine working on the Miller/Atkinson cycle, wherein a space underside the piston crown is divided by a separator into two complimentary sections communicating with each other through a passage controlled by a valve so that the engine avoids the subpressure under the piston crown.

### BACKGROUND OF THE INVENTION

In the GB2,478,635 patent by a slight modification of the MultiAir electro-hydraulic valve system of FIAT/INA it is achieved an infinity of additional, and more efficient, modes (unlimited Miller/U.S. Pat. No. 2,773,490 cycle) for four-stroke engines. The basic idea is to avoid the sub-pressure during the induction stroke and during the compression stroke, and so to reduce the relative pumping loss, which at light loads is a significant part of the indicated power.

In the WO92/17694 international application, titled “Harmonic Reciprocating Heat Engine”, a two-stroke harmonic engine with “four-stroke-like” lubrication is presented. The piston performs pure sinusoidal (or harmonic) motion: the relation between the piston displacement D and the rotation angle F of the power shaft is: D=(S/2)*sin(F), wherein S is the piston stroke. The pure sinusoidal motion of the piston enables the perfect balancing of the inertia forces, of the inertia torques and of the inertia moments, as explained in the WO94/03715 application, without the need of external balancing shafts. The vibration-free quality of this simple engine is as the vibration-free quality of the Wankel Rotary engine.

### BRIEF DESCRIPTION OF THE INVENTION

The engine of FIGS. 17 and 18 of the abovementioned WO92/17694 application, which is the closest prior art of the present invention, can, with a slight modification, turn to a more efficient, more environmental-friendly, simpler and cheaper two stroke by avoiding the subpressure (and the relative pumping loss) at light loads and idling (a kind of unlimited Miller cycle in the two-strokes).

The same idea is applicable to any conventional (i.e. based on a conventional “crankshaft-connecting rod-piston” mechanism) two-stroke engine (single cylinder or multicylinder of any arrangement) wherein the piston is properly modified; with a separator the space between the two ends of the piston is divided into two sections; the separator comprises a passage between the two sections and a valve that controls the passage from fully closed to wide open; with the two sections having a constant total volume, the passage, depending on the position of the valve, allows a part of the air or mixture into the one section to pass to the other section; the engine needs not other control means for the load control: all it takes is the valve that controls the passage through which the two sections communicate. The big difference this invention brings to the two-strokes is at light loads and idling (i.e. wherein an engine of a vehicle—like a motorcycle or a scooter or a car—spends most of its life). With the valve keeping the passage between the two sections closed, the engine runs as a conventional two-stroke keeping the known two-stroke advantages (lightweight, high power to weight ratio, compact, simple etc).

### SUMMARY OF THE INVENTION

The double acting piston of the closest prior art (FIGS. 17 and 18) comprises two piston crowns and a rod (or post) wherein the two piston crowns are secured to; a hole/bearing is at the middle of the rod. The piston is rotatably mounted on a linearly reciprocating pin. A wall seals the crankcase of the engine from the space between the two piston crowns inside the cylinder (enabling the lubrication/cooling/cleaning of the parts inside the crankcase with oil that recycles), the wall also divides the space inside the cylinder and between the two piston crowns into two independent sections. The lubricant consumption is substantially reduced: with the thrust forces from the piston skirts to the cylinder liners eliminated, only a thin film of lubricant is required on the cylinder liner to prevent the metal-to-metal contact (scuffing) of the piston rings with the cylinder liner. It is apparent that as the piston reciprocates, the sum of the volumes of the two sections underside the two piston crowns remains constant.

### BRIEF DESCRIPTION OF THE DRAWINGS

FIG. 1 shows the second embodiment with the cylinder partially sliced to unhide the piston and the separator/valve.

FIG. 2 shows the embodiment of FIG. 1 exploded. At right it is shown the separator/valve assembled (top) and disassembled. At right it is shown the piston sliced, with its compression ring at its top (or first) end and its oil scraper ring at its bottom (or second) end. The first and second ends of the piston are secured to each other by the piston skirt which comprises longitudinal cuts to allow the separator/valve be supported. At left it is shown the reed and the transfer port, they are also shown two exhaust ports. The piston, by means of its skirt, opens and closes the exhaust and the transfer ports.

FIG. 3 shows the engine of FIG. 1 at five different crankshaft angles (per 45 degrees). As the piston moves from the TDC to the BDC the volume of the first section increases as much as the volume of the second section decreases.

FIG. 4 shows what FIG. 3 from a different viewpoint.

FIG. 5 shows a version of the first embodiment wherein intake ports controlled by the piston substitute the reed valve.

FIG. 6 shows the engine of FIG. 5 exploded. At the lower side of the piston skirt there are openings to allow, when the piston is near its TDC, air from inlet ports made on the cylinder to enter into the first section. The cylinder comprises inlet ports, exhaust ports (they are above the inlet ports and they are controlled by the skirt of the piston) and transfer ports. The separator/valve extends through the longitudinal cuts of the piston skirt for its support on the cylinder.

FIG. 7A shows the variation (curve A) of the volume of the space underside the piston of the first cylinder of the two-cylinder two stroke engine of the U.S. Pat. No. 8,683,964 patent, it also shows (curve B) the variation of the volume of the space underside the piston of the second cylinder, it also shows (curve C) the variation of the volume of the combined space underside the two pistons of the paired cylinders (i.e. of the variation of the total volume).

FIG. 7B shows what FIG. 7A for the case of a harmonic engine having paired cylinders, and for the case of the first embodiment with the harmonic double-acting piston.

FIG. 7C shows the variation (curve A) of the volume in the first section of the second embodiment, the variation (curve B) of the volume of the second section of the second embodiment, it also shows (curve C) the variation of the volume of the space between the first and second ends of the piston.

FIG. 8 shows a first embodiment. The throttle valve that controls the passage between the first section and the second section is wide open.

FIG. 9 shows the first embodiment after the removal of the two roller bearings wherein the power shaft is supported. The throttle valve is shown partially open. The wall 25 seals the “crankcase” from the first and second sections inside the cylinder.

FIG. 10 shows what FIG. 9 after the removal of the power shaft. They are shown the two intermeshed gearwheels. The throttle valve closes the passage between the two sections.

FIG. 11 shows what FIG. 10 after several degrees of rotation of the power shaft. The volumes of the two sections (at the two sides of the throttle valve) have changed a lot, but the closed passage does not allow flow of air or mixture between them.

FIG. 12 shows what FIG. 11 after several degrees of rotation of the power shaft. The casing and the cylinder have been removed.

FIG. 13 shows the moving parts (plus the immovable inner, or ring, gearwheel at left) of the first embodiment.

FIG. 14 shows, from two different viewpoints, the wall that seals the “crankcase” from the cylinder, a part of the cylinder and the throttle valve wide open.

FIG. 15 shows what FIG. 14 with the throttle valve partially open.

FIG. 16 shows what FIG. 14 with the throttle valve closing, almost completely, the passage from the one section to the other.

FIGS. 17 and 18 show the engine of the Prior Art wherein the first embodiment of the present invention is based upon.

### PREFERRED EMBODIMENTS

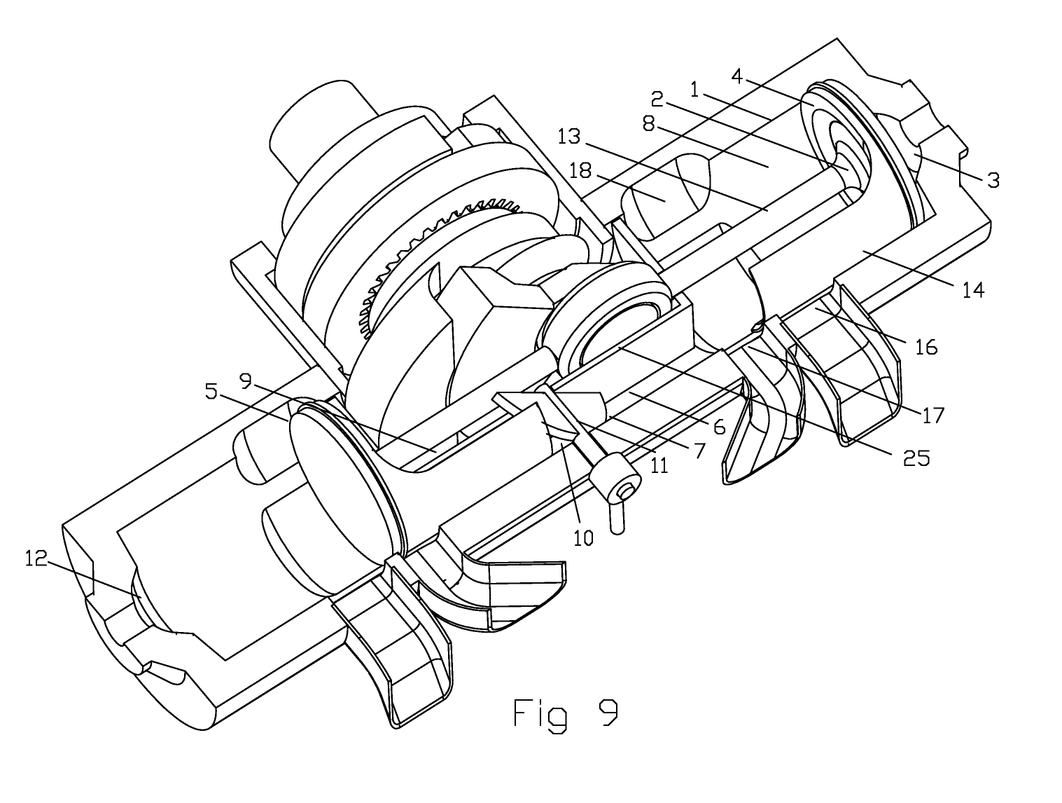

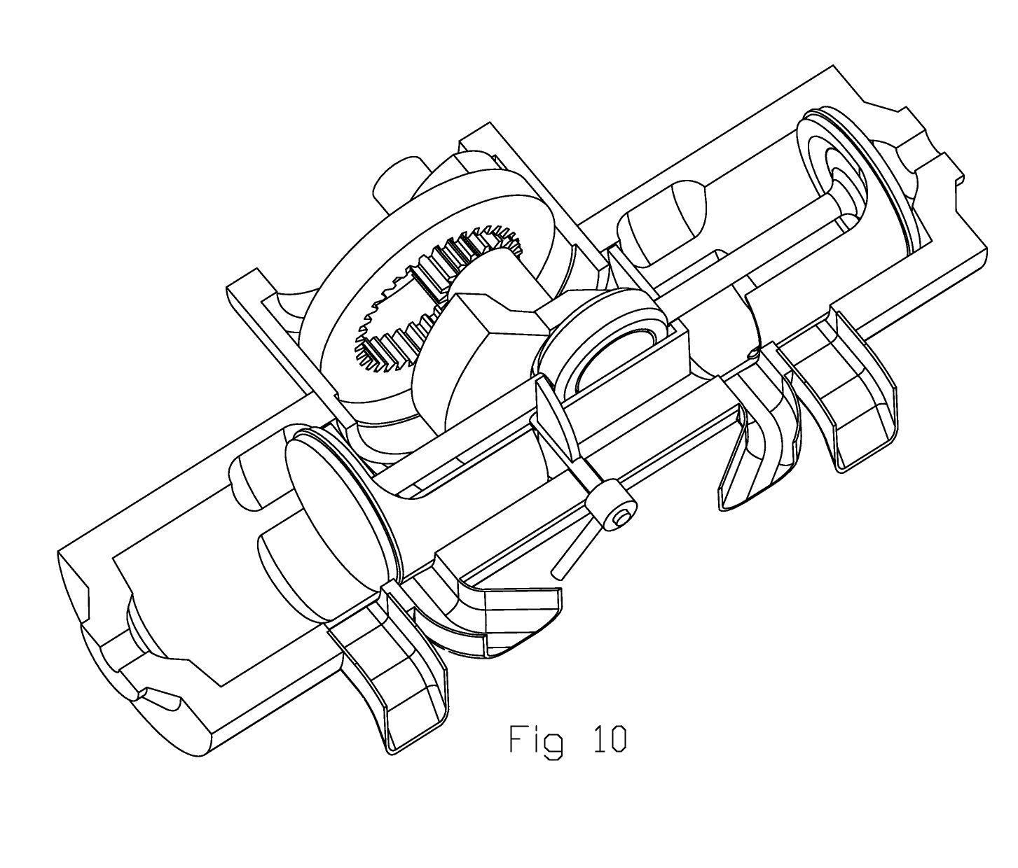

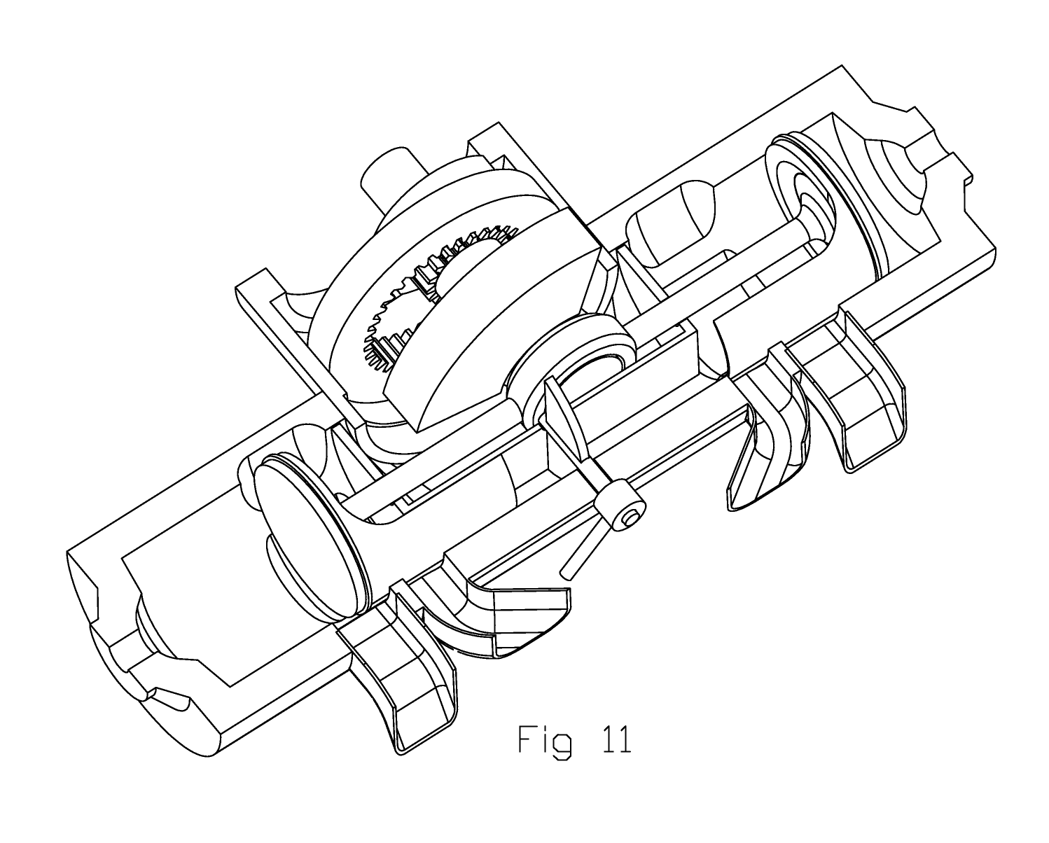

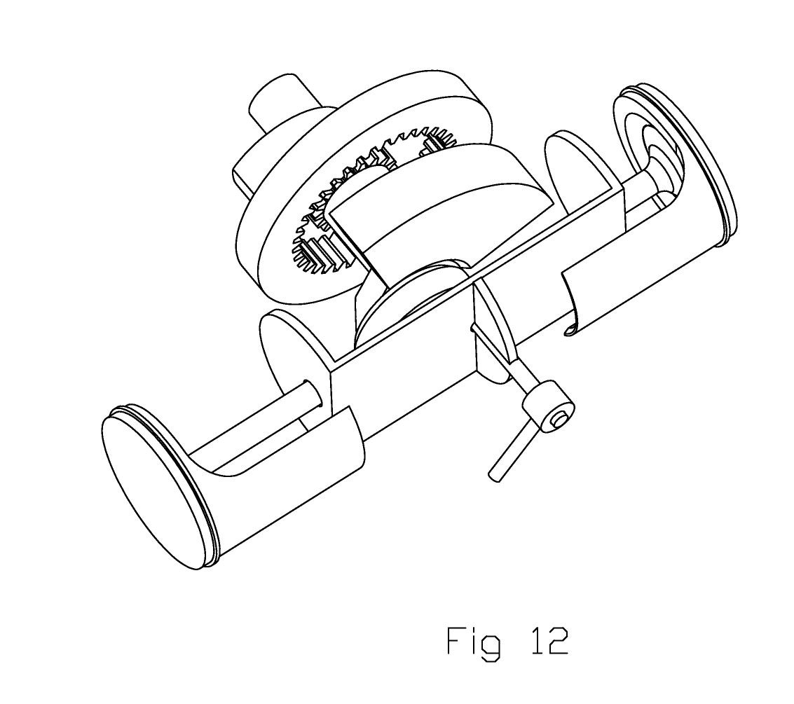

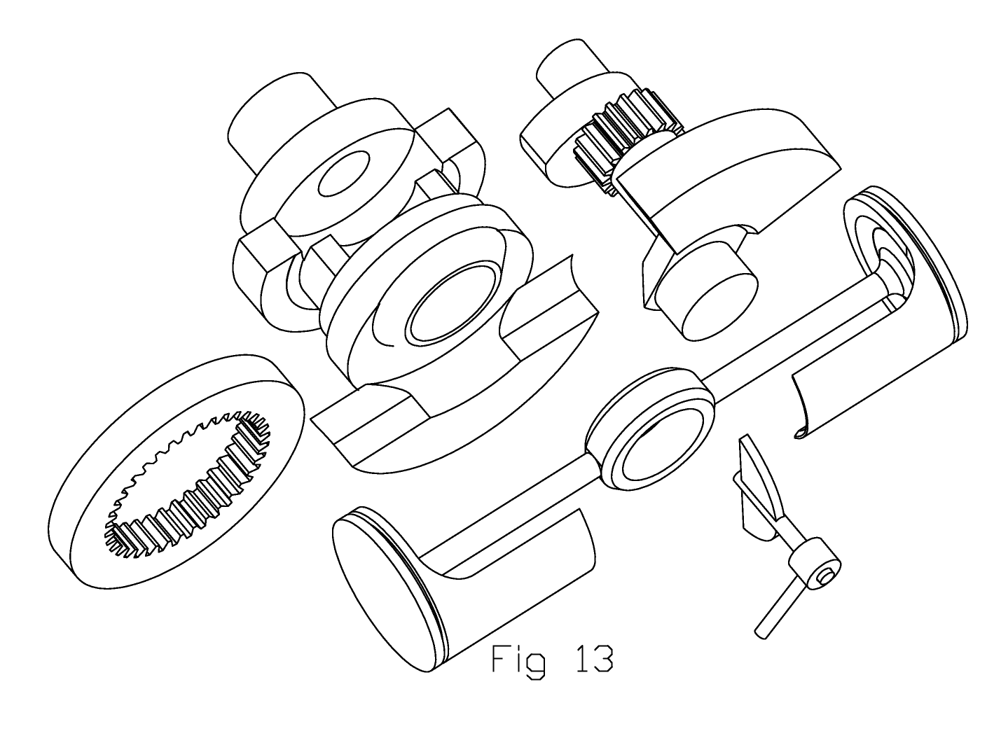

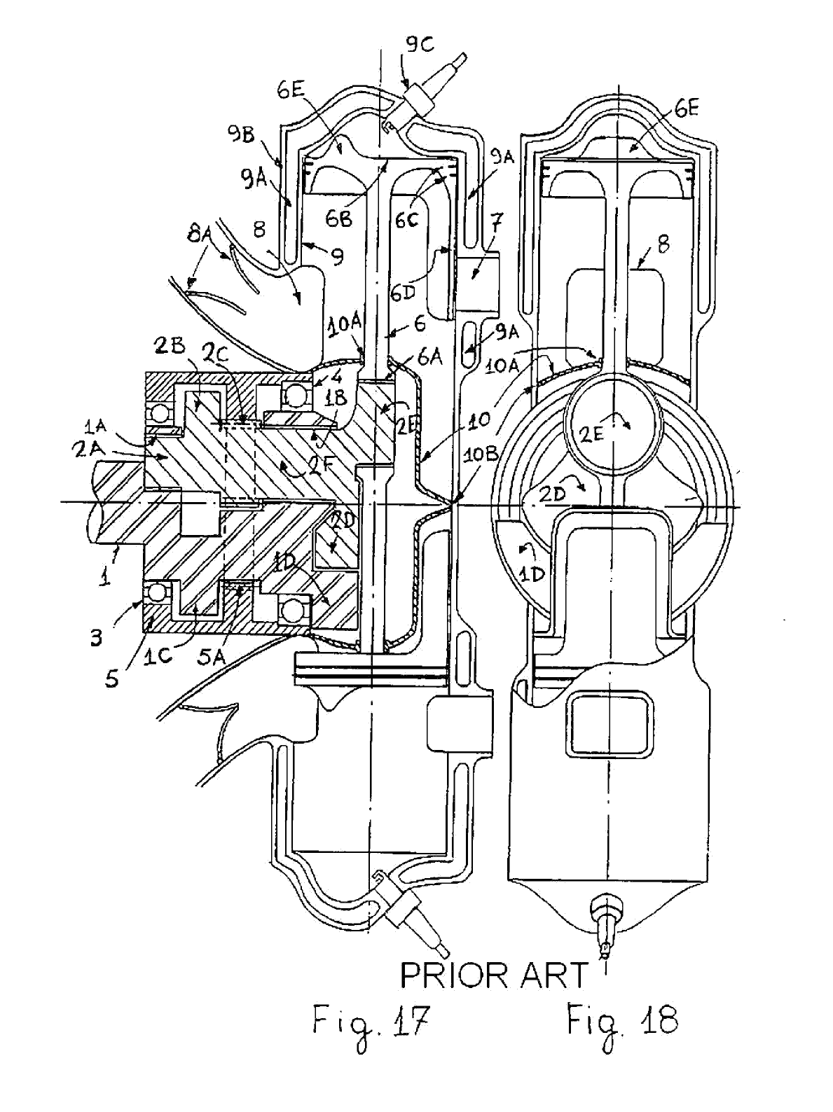

In a first preferred embodiment, FIGS. 8 to 16, the harmonic engine of the closest prior art (shown in FIGS. 17 and 18) is slightly modified: now the two sections communicate through a wide passage, with a throttle valve controlling this passage. With the passage completely closed by the throttle valve, the engine operates just like the engine of the closest prior art (FIGS. 17 and 18) wherein the two sections are isolated from each other.

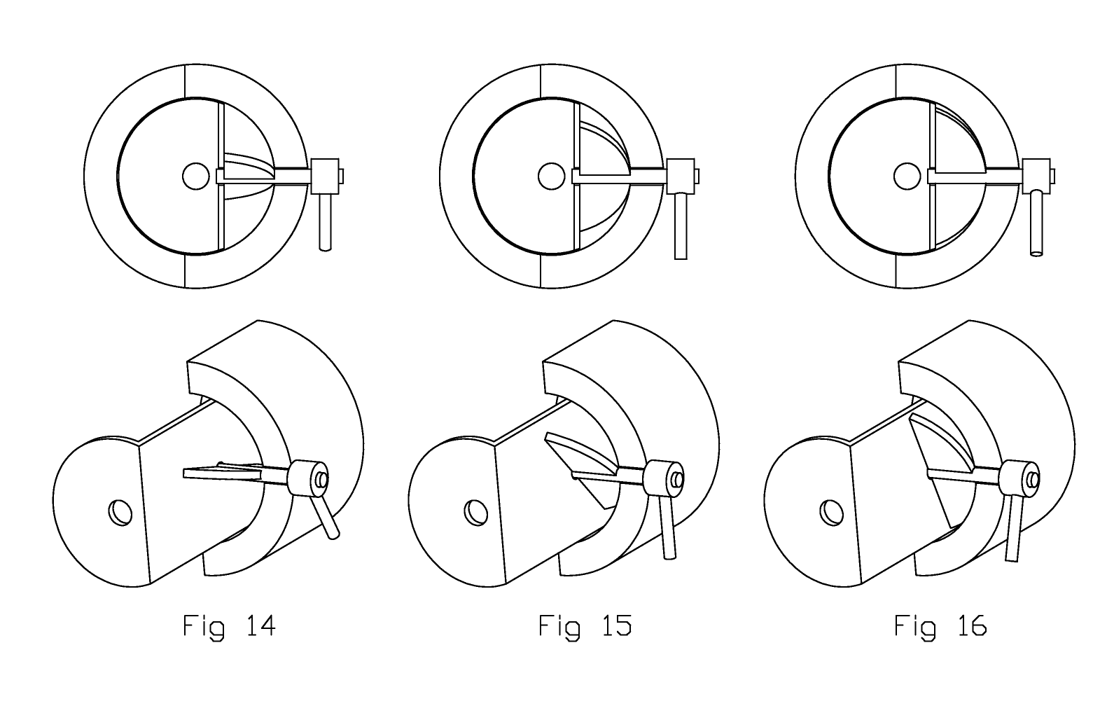

The modified engine (FIGS. 8 to 16) needs not some external throttle valve(s) for the control of the load. When the passage is wide open (the plane of the throttle valve is nearly parallel to the cylinder axis, as in FIG. 14), the upper and lower sections communicate freely, and the pressure in the two sections remains nearly constant, because the total volume of the space inside the cylinder and between the two piston crowns, is constant; as the piston moves upwards, the instant increase of the volume of the upper section equals to the instant decrease of the volume of the lower section; similarly when the piston moves downwards. the piston performs a pure sinusoidal motion,

If the second end of the piston is sealing one side of a second combustion chamber 12, the piston becomes a double acting piston having a post 13 connecting its two ends.

Load Control:

With the passage between the two sections nearly (as in FIG. 16) or completely closed by the throttle valve, the engine runs at full load: as the piston moves upwards, the volume of the upper section increases and air or mixture from the reed valve (or from inlet port controlled by the piston) is suctioned; as the piston moves downwards, the reed valve (or the inlet port) closes and the trapped air/mixture is compressed inside the upper section; later, when the transfer ports of the upper cylinder open by the downwards moving piston, the compressed air or mixture enters and scavenges the upper cylinder.

With the passage partially open (throttle valve at an intermediate position, FIG. 15), the engine runs at partial load: as the piston moves upwards, air or mixture from the reed valve (or from the inlet port) and from the lower section fills the vacuum in the upper section; the more open the passage, the less the air or mixture that enters from the upper reed valve (or the upper inlet port); during the downwards motion of the piston, a part of the air or mixture previously entered into the upper section passes, through the partially open passage, to the lower section; when the downwardly moving piston finally opens the transfer ports of the upper cylinder, the pressure in the upper section is reduced as compared to the case of the full load (wherein the passage was closed), and so the engine runs under a lighter load.

With the passage wide open (throttle valve at a wide open position as in FIG. 14), the engine runs stable and green at a low idle: the pressure in the upper section drops only slightly; a small quantity of air or mixture enters into the upper section through the upper reed valve (or through the upper inlet port), and a large quantity of air or mixture from the lower section, through the wide open passage, enters and fills the upper section; during its downwards motion the piston displaces most of the air or mixture from the upper section back to the lower section with little resistance (this is important as regards the pumping loss and the specific fuel consumption at partial loads and idling); when the transfer ports of the upper cylinder open by the piston, the pressure in the upper section is small, so the quantity of air or mixture that finally enters in the upper cylinder is small and the engine runs at idle.

That is, the engine control can completely be based on the position of the valve that opens and closes the passage between the two sections. The constant total volume of the two sections is crucial for the control of the engine at light loads and idling as explained in the following.

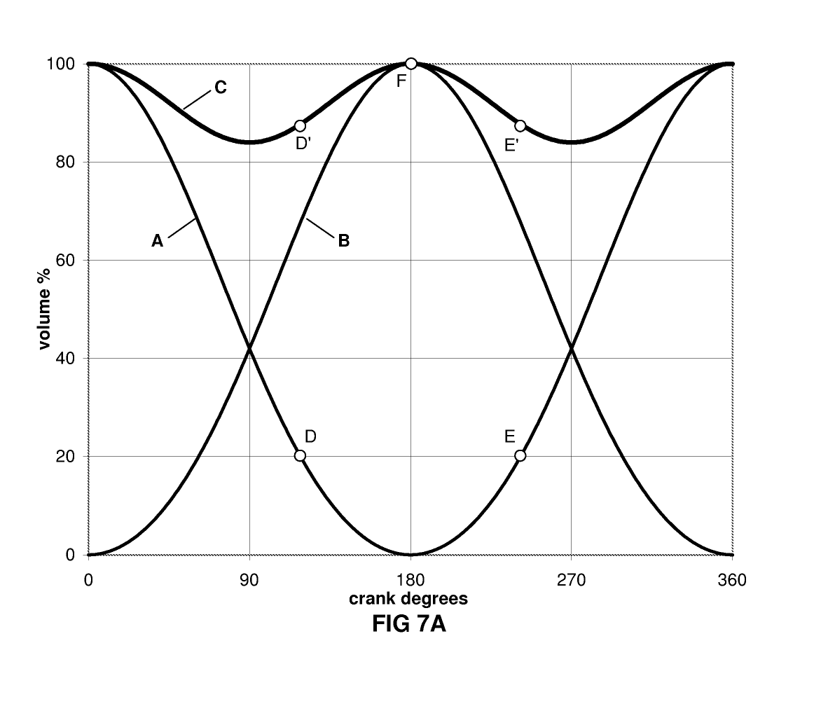

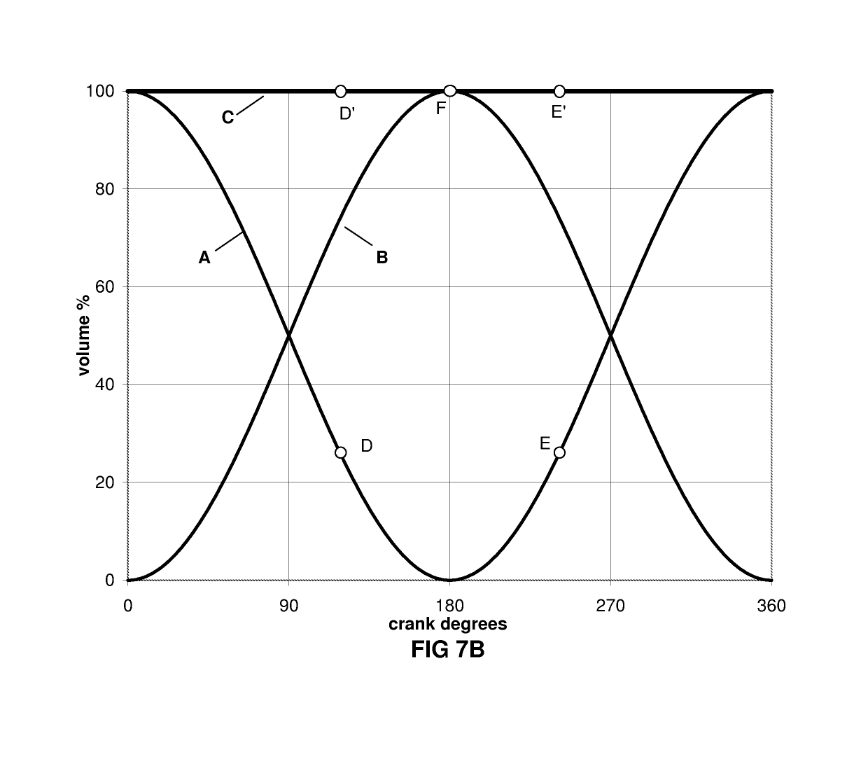

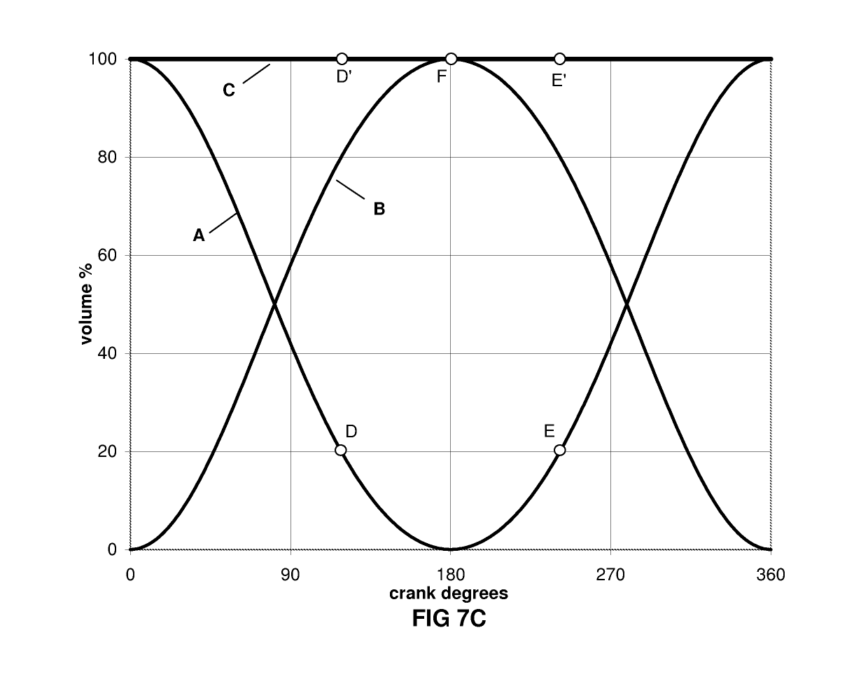

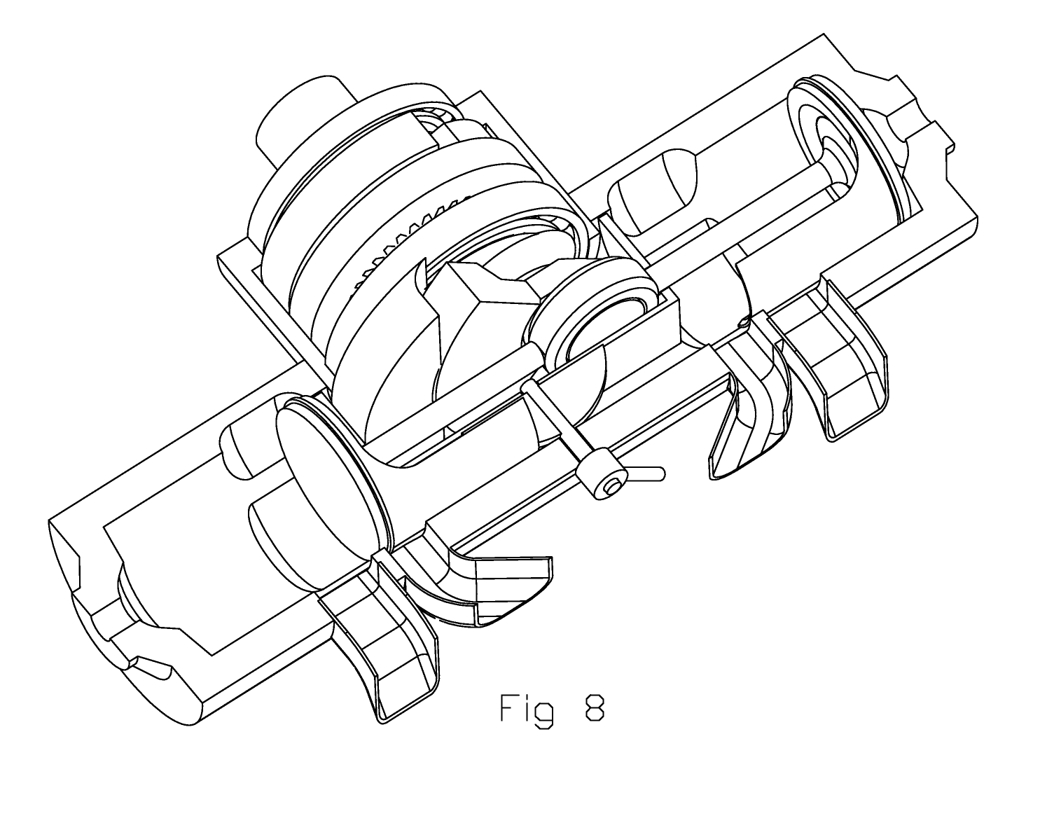

In the U.S. Pat. No. 8,683,964 (Basil Van Rooyen) it is proposed a two-cylinder two-stroke engine wherein a bypass valve is disposed between two inlet ports short-circuiting the sections underside the two piston crowns and creating a combined volume. According the abovementioned patent, the partial load operation is improved, the pumping loss is substantially reduced, and the load control is simplified. In the FIG. 7A the curve A is the variation vs. the crankshaft angle of the volume underside the first piston of the above U.S. Pat. No. 8,683,964 patent, the curve B is the variation vs. the crankshaft angle of the volume underside the second piston. Each of the two pistons is connected to a conventional crankshaft by a conventional connecting rod. The curve C is the sum of the variations of the volumes underside the two pistons vs. the crankshaft angle (i.e. it is the sum of the A and B curves). With the “connecting rod to stroke ratio” being 1.6, the total volume (curve C) varies more than 16%. For smaller “connecting rod to stroke” ratios, the variation of the C curve is wider. The point D on the A curve is where the first piston opens its respective transfer ports. The point D′ on the C curve shows the volume of the combined space underside the two piston crowns the moment the first piston opens its transfer ports. As the first piston approaches its BDC, the combined space increases, causing some 15% of the burnt gas from inside the first cylinder to return to the combined space (case with wide open bypass passage), contaminating and heating the fresh air or mixture (an open transfer port provides substantially smaller resistance in the motion of a gas than a closed reed valve). After the point F at the TDC of the first piston, the volume of the combined space underside the two piston crowns decreases, forcing some 15% of the trapped air or mixture to pass the transfer ports and get into the first cylinder. After 180 crankshaft degrees the same happen in the second cylinder. That is, with the bypass valve wide (or completely) open and low-medium revs, per crank rotation at least 30% of the one cylinder capacity enters into the two cylinders, and at least some 30% of residual gas contaminates the air of mixture in the combined space underside the two piston crowns. This is an undesired limitation for the idle and the light load operation of the engine because it defines the quality and the revs of the idling; worse even, it makes necessary additional load control means (other than the bypass valve) for the idle and the light load operation, canceling advantages like the reduced pumping loss, the simplicity, the compactness, the low cost. As noted in U.S. Pat. No. 8,683,964:

“(In practice a butterfly valve maybe provided in the inlet conduit, not for throttle control but for the purpose of idle setting. Above these very slow idle speeds, this butterfly valve would open fully, and the engine speed and power would be controlled solely by the by-pass valve, and not by the butterfly valve or any other throttle arrangement upstream of the bifurcation point.)”.

So, while the U.S. Pat. No. 8,683,964 invention is limited in engines having pairs of cooperating cylinders (the space underside the piston of the first cylinder cooperates with the space underside the piston of the second cylinder), the control of the engine has inherent limitations and the pumping loss at idling and light loads is significant. This is because in a conventional “crankshaft/connecting rod/piston” engine, the motion of the piston is substantially faster near the TDC than near the BDC, so even with the pistons phased 180 crankshaft degrees from each other, the volume of the combined space underside the pistons in the two paired cylinders varies substantially. With infinite “connecting rod to stroke” ratio (which results in pure sinusoidal, or harmonic, motion of the pistons) this deficiency is eliminated. Instead of using infinitely long connecting rods, there are other ways to achieve the harmonic motion of the piston, as described in WO92/17694.

In a Harmonic engine the piston performs a pure sinusoidal motion, with the volume of the combined space being constant, allowing true, complete and unlimited control over the idle and light load operation, avoiding the pumping loss and the complication related with the need for additional control means. As FIG. 7B shows, the increase of the volume underside the one piston of the Harmonic engine equals with the decrease of the volume underside the other piston, giving a combined space of constant volume. The comparison of the FIG. 7A with the FIG. 7B explains the difference.

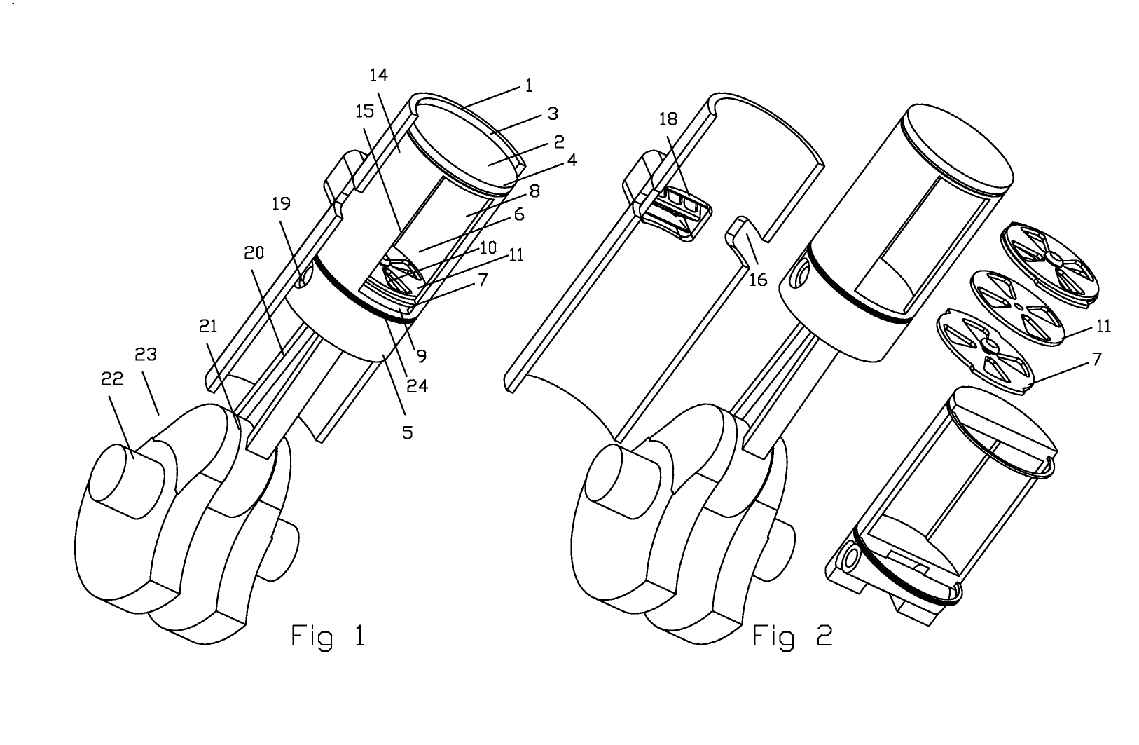

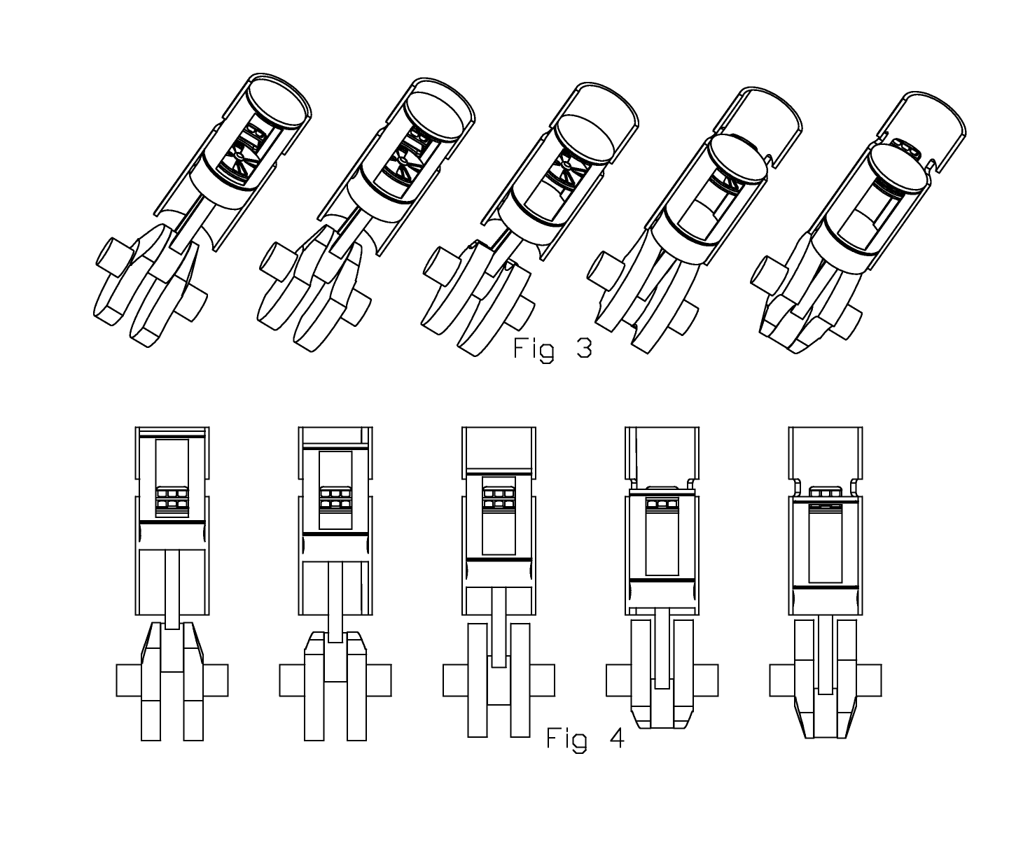

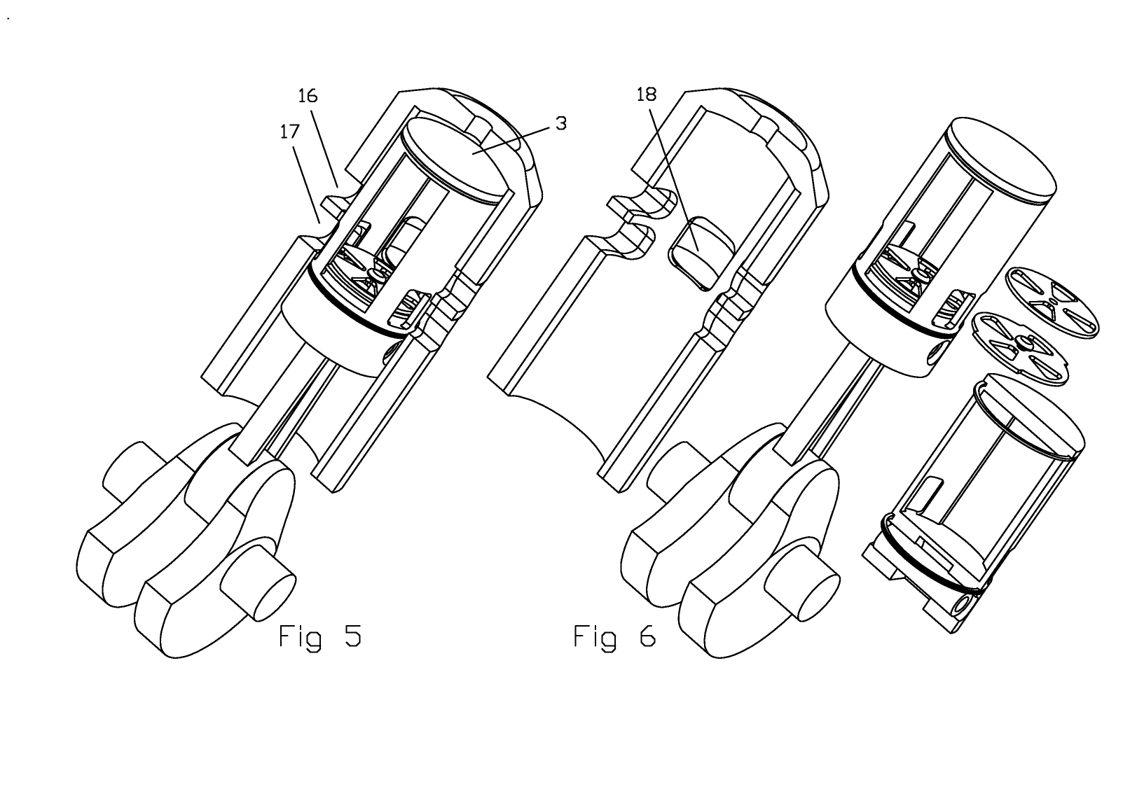

In a second preferred embodiment, FIGS. 1 to 6, a single cylinder two-stroke engine comprises:

a cylinder 1;
a piston 2 slidably fitted in said cylinder 1, said piston 2 sealing one side of a combustion chamber 3 defined by said piston 2 and said cylinder 1, said piston 2 having a first end 4 adjacent said combustion chamber 3 and a second opposite end 5;
a space 6 defined between said first end 4 and said second end 5, said space 6 being divided, by a separator 7, into a first section 8, defined between said first end 4 and said separator 7, and a second section 9 defined between said second end 5 and said separator 7, said separator comprising a passage 10 and a valve 11 controlling said passage 10,
so that the reciprocation of the piston varies the volume of the combustion chamber, the volume of the first section and the volume of the second section, and the communication of the first section with the second section is controlled by the valve.

The piston skirt 14 connects the first end and the second end of the piston, the piston skirt comprises longitudinal openings 15 enabling the support of the separator onto the cylinder, the piston skirt controls exhaust ports 16 (and inlet ports 17).

With the total volume of the first and second sections being constant, as shown in FIG. 7C (wherein the A curve in the “variation vs. crankshaft angle” of the volume of the first section, wherein B is the “variation vs. crankshaft angle” of the volume of the second section and C is the sum of A and B), the single cylinder two-stroke can use the valve in the passage for the control of the load of the engine “all the way”: from full load to idling; with the “complimentary” second section, the pumping loss is reduced as in the four-stroke engines running on Miller/Atkinson cycle wherein the intake valves stay wide open during a controllable part of the compression stroke to allow a smaller or bigger part, or almost all (at idling), of the charge to return to the intake manifold at small friction (aerodynamic loss). In a similar way, and depending on the revs and on how much the valve opens the passage between the two sections, the single-cylinder two-stroke of the present invention allows a smaller or bigger part, or almost all (at idling), of the air or mixture suctioned into the first section to pass to the second section at small energy expense.

The separator 7 in cooperation with the cylinder 1 and the piston skirt 14 seals the two sections 8 and 9. The communication between the combustion chamber 3 and the first section 8 is through transfer ports 18 controlled by the piston 2.

The piston 2, by means of a wrist pin 19 at its second end 5, and by means of a connecting rod 20, is connected to a crankpin 21 of a crankshaft 22 in a crankcase 23; an oil scraper ring 24 mounted on the second end 5 of the piston 2 keeps the lubricant into the crankcase as in the four-stroke engines (i.e. a conventional four-stroke oil scraper ring in a ring groove above the wrist pin).

In a third embodiment the valve opens and closes in synchronization to the reciprocating piston to further reduce the pumping loss (and the energy spent to overcome the aerodynamic resistance): the valve is wide open for a part of the cycle allowing the free pass of the charge from the one section to the other, and then closes isolating the two sections. For instance, the valve can be an electronically controlled hydro-mechanical valve as those used in mass production in the four-stroke MultiAir engines of FIAT-INA: the control unit triggering a high-speed solenoid valve opens and closes the valve that controls the passage between the two sections. Just like the valves of the MultiAir system connect and disconnect (under the accurate control of an electronic unit) the inlet manifold with the combustion chamber, a similar valve under the control of an electronic unit can connect and disconnect the first section with the second section, minimizing the throttling even at medium loads. Despite the fact that the two-stroke becomes more complex, the added complexity has to do only with the software of the control unit and not with the hardware of the engine.

The present invention fits with (and is applicable to) every two-stroke engine (single cylinder or multicylinder, small or big, conventional or unconventional). The advantages it offers are more apparent in engines that operate at variable revs and loads.

Although the invention has been described and illustrated in detail, the spirit and scope of the present invention are to be limited only by the terms of the appended claims.

What is claimed is:

1. A two-stroke reciprocating internal combustion engine comprising at least:
a cylinder;
a piston slidably fitted in said cylinder, said piston sealing one side of a combustion chamber defined by said piston and said cylinder, said piston having a first end adjacent said combustion chamber and a second opposite end;
a space defined between said first end and said second end, said space being divided, by a separator, into a first section, defined between said first end and said separator, and a second section defined between said second end and said separator, said separator comprising a passage and a valve controlling said passage,
so that the reciprocation of the piston varies the volume of the combustion chamber, the volume of the first section and the volume of the second section,
and the communication of the first section with the second section is controlled by the valve.

2. A two-stroke reciprocating internal combustion engine as in claim 1, wherein the sum of the volumes of said first section and said second section is substantially constant during the reciprocation of the piston.

3. A two-stroke reciprocating internal combustion engine as in claim 1, wherein the separator is slidably fitted to the cylinder, the displacement of the separator varies the ratio of the volumes of the first and second sections.

4. A two-stroke reciprocating internal combustion engine as in claim 1, wherein the piston performs a pure sinusoidal motion.

5. A two-stroke reciprocating internal combustion engine as in claim 1, wherein:
the piston performs a pure sinusoidal motion,
the second end of the piston is sealing one side of a second combustion chamber,
thereby the piston becomes a double acting piston.

6. A two-stroke reciprocating internal combustion engine as in claim 1, wherein the valve is the main control of the load of the engine.

7. A two-stroke reciprocating internal combustion engine as in claim 1, wherein:
the first end and the second end of the piston are connected by a post, said post passing through a hole of the separator.

8. A two-stroke reciprocating internal combustion engine as in claim 1, wherein:
the first end and the second end of the piston are connected by the piston skirt, the piston skirt comprises longitudinal openings allowing the support of the separator onto the cylinder, the piston skirt controls exhaust ports and inlet ports.

9. A two-stroke reciprocating internal combustion engine as in claim 1, wherein:
the valve is a disk valve or a butterfly valve.

10. A two-stroke reciprocating internal combustion engine as in claim 1, wherein the piston through a wrist pin at its second end, and through a connecting rod, is connected to a crankpin of a crankshaft in a crankcase, an oil scraper ring mounted on the second end of the piston seals the crankcase lubricant.
